(19) United States
(12) Patent Application Publication
(10) Pub. No.: US 2012/0123054 A1
(43) Pub. Date: May 17, 2012

(54) CURABLE COMPOSITION, HEAT CONDUCTIVE RESIN MOLDED PRODUCT AND SEMICONDUCTOR PACKAGE

(75) Inventors: Kazuaki Matsumoto, Settsu-shi (JP); Satoshi Katayama, Settsu-shi (JP)

(73) Assignee: KANEKA CORPORATION, Osaka-shi (JP)

(21) Appl. No.: 13/296,630

(22) Filed: Nov. 15, 2011

(30) Foreign Application Priority Data
Nov. 16, 2010 (JP) 2010-255991

(51) Int. Cl. C08K 3/38; C08K 3/22; C08K 3/10

(52) U.S. Cl. 524/701; 524/786; 524/783

(57) ABSTRACT

A curable resin composition containing:
(A) an organic compound containing in a molecule at least two carbon-carbon double-bonds having reactivity with a SiH group;
(B) a compound containing in a molecule at least two SiH groups; and
(C) a heat-conductive filler, which is at least one species selected from the group consisting of a-alumina, hexagonal boron nitride, aluminum nitride and zinc oxide, and is a particle wherein a primary particle has a number average particle diameter of at least 0.10 μm,
wherein heat conductivity after curing is at least 0.8 W/mK.

### CROSS-REFERENCE TO RELATED APPLICATIONS

The present application claims priority under 35 U.S.C. §119 to Japanese Patent Application No. 2010-255991, filed Nov. 16, 2010. The contents of this application are incorporated herein by reference in their entirety.

### TECHNICAL FIELD OF THE INVENTION

The present invention relates to a curable resin composition, a resin molded product as well as a semiconductor package which have excellent heat resistance, light resistance, light reflectance, and the like.

### BACKGROUND OF THE INVENTION

In recent years, improvement of capabilities of electronic devices such as personal computers, cellular phones and PDAs has been remarkable, and with the miniaturization that proceeds concomitantly to the improvement of capabilities, the heat density (amount of heat generated per volume) of semiconductors has been increasing remarkably. Light-emitting diodes may be cited as semiconductors with particularly large heat density.

As packages for semiconductors, various types have been proposed. For light-emitting diodes, for instance, those of the surface-mount type are manufactured, and mainly polyamide resins, polyester resins or the like are used as packaging materials thereof.

The life span of a semiconductor is reduced by the increase of the operating temperature. Since a light-emitting diode has a large heat density, the temperature of the heat-generating center of a package that uses the above materials reaches a high temperature of almost 150° C. Therefore, it is required to decrease the temperature of the heat-generating center. Since light is also generated when the semiconductor is a light-emitting diode, the semiconductor packaging resins are all the more required to have resistance to heat or resistance to heat and light. With respect to these requirements, a hybrid resin, which cures by hydrosilylation reaction, having extremely excellent resistance to heat and light has been reported as a resin for semiconductor packages (Japanese Patent Application Pub. No. 2005-146191).

Meanwhile, although being a general-purpose silicone resin composition, a heat-resistant and light-resistant composition capable of keeping small the temperature increase of the heat-generating center, not by improving the heat resistance but by improving heat conductivity, has also been disclosed (Japanese Patent Application Pub. No. 2010-018786).

Japanese Patent Application Pub. No. 2002-3718 discloses heat-conductive silicone composition containing (A) an organopolysiloxane having at least two alkenyl groups in a molecule, (B) an organohydrogenpolysiloxane having at least two silicon atom-bound hydrogen atoms in a molecule and (C) a filler using both an aluminum powder and a zinc oxide powder.

While the temperature increase of a semiconductor can be suppressed to some extent using such materials, in recent years, as brighter light-emitting diodes have been developed, compositions excellent in heat resistance, light resistance and heat-conductivity are desired. At the same time, in order to improve the light extraction efficiency of light-emitting diodes, resin compositions having high whiteness and light reflectance are also desired.

A technique is known, in which zinc oxide nano-particles are added to a hybrid resin which cures by hydrosilylation reaction so as to control the refractive index of the transparent optical material (Japanese Patent Application Pub. No. 2010-138270). However, with such a method, a resin composition with high whiteness and high light reflectance cannot be obtained as the resin composition transmits light. In addition, it is generally known that, even though nano-particles are added, the effect of improving the heat conductivity of the resin composition cannot be obtained since there are little opportunities for the surfaces of the particles to come into contact with one another.

In addition, in the production of a light-emitting diode, filling the interior of a package with a sealant (molding material) such as epoxy resin is common. In this case, there is also the problem that sealant interface detachment or cracking is caused by concentration of heat stress or the like, attributed to a difference in the linear expansion coefficient between the package and the sealant, decreasing the reliability of the light-emitting diode. Consequently, in order to improve reliability, suppressing sealant interface detachment or cracking is also desired.

### SUMMARY OF THE INVENTION

For a resolution of these problems, an object of the present invention is to provide a resin composition for optical component which have excellent heat resistance, light resistance, heat-conductivity, whiteness and light reflectance.

Namely, the present invention relates to a curable resin composition containing:

(A) an organic compound containing in a molecule at least two carbon-carbon double-bonds having reactivity with a SiH group;

(B) a compound containing in a molecule at least two SiH groups; and

(C) a heat-conductive filler, which is at least one species selected from the group consisting of a-alumina, hexagonal boron nitride, aluminum nitride and zinc oxide, and is a particle wherein a primary particle has a number average particle diameter of at least 0.10 μm,

wherein heat conductivity after curing is at least 0.8 W/mK.

The compound (B) is preferably a compound obtained by a hydrosilylation reaction between an organic compound (B-1) containing in a molecule at least two carbon-carbon double-bonds having reactivity with a SiH group and a silicon compound (B-2) containing at least two SiH groups in a molecule.

The organic compound (B-1) preferably has a heterocyclic skeleton or an alicyclic skeleton.

The organic compound (B-1) is preferably a compound represented by the following general formula (1):

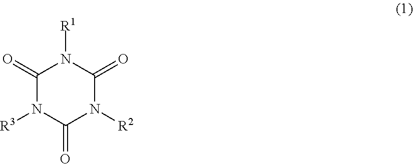

wherein R¹, R² and R³ all represent organic groups, and at least two of them are alkenyl groups.

The heat-conductive filler (C) is preferably zinc oxide.

The volume ratio of the zinc oxide is preferably 5 to 90% by volume of the whole composition.

The curable resin composition preferably further contains a hydrosilylation catalyst (D).

The curable resin composition preferably further contains a silica (E).

The present invention also relates to a heat-conductive resin molded product obtained by a hydrosilylation reaction of the curable resin composition of the present invention.

The initial reflectance at the wavelength of 450 nm of the heat-conductive resin molded product is preferably at least 75%.

The present invention also relates to a package for semiconductor containing the heat-conductive resin molded product of the present Invention.

It is preferable that the semiconductor package uses a light-emitting diode as the semiconductor.

### BRIEF DESCRIPTION OF THE DRAWINGS

FIG. 1 is a figure of an example of a package of light-emitting diode.

FIG. 2 is a figure of a light-emitting diode package produced in Examples.

### DESCRIPTION OF THE EMBODIMENTS

Hereafter, the present invention is described in detail.

### [Curable Resin Composition]

### [Component (A)]

The component (A) is not limited in particular as long as it is an organic compound containing in a molecule at least two carbon-carbon double-bonds having reactivity with a SIR group. The bond positions of the carbon-carbon double-bonds having reactivity with a SiH group are not limited in particular, and can be present anywhere within the molecule. The component (A) may be a linear or branched chain. A single compound may be used as the component (A) or two or more compounds may be used in combination.

The organic compound may be classified into organic polymer compounds and organic monomer compounds. Examples of the organic polymer compounds, although not limited in particular, may include polysiloxane compounds, polyether compounds, polyester compounds, polyarylate compounds, polycarbonate compounds, saturated hydrocarbon compounds, unsaturated hydrocarbon compounds, polyacrylic acid ester compounds, the polyamide compounds, the phenol-formaldehyde compounds (phenol resin compounds), and the polyimide compounds. As the organic compounds, those other than compounds containing a siloxane unit (Si—O—Si), such as polysiloxane-organic block copolymers and polysiloxane-organic graft copolymers, may be used, and compounds containing no elements other than C, H, N, O, S and halogen as constituent elements may also be used. Examples of organic monomer compounds, although not limited in particular, may include aromatic hydrocarbon compounds such as phenol compounds, bisphenol compounds, benzene and naphthalene; chain or cyclic aliphatic hydrocarbon compounds; heterocyclic compounds; and mixtures thereof.

As the carbon-carbon double-bonds having reactivity with a SiH group, although not limited in particular, groups represented by the following general formula (2):

CH₂═CR⁴— (2)

(wherein R⁴ represents a hydrogen atom or a methyl group) are suitable from the point of reactivity. Among these, the group in which R⁴ is a hydrogen atom is particularly preferable since the material is readily obtained.

In addition, as the carbon-carbon double-bonds having reactivity with a SiH group, alicyclic groups having within the ring the partial structure represented by the following general formula (3):

—R⁵C═CR⁵— (3)

(wherein R⁵ represents a hydrogen atom or a methyl group; the two R^{5s} may be the same or different) are preferable from the point that the heat resistance of the cured product is high. Among these, the group in which both R⁵s are a hydrogen atom is particularly preferable since the material is readily obtained.

The carbon-carbon double-bonds having reactivity with a SiH group may be bonded directly to the skeleton portion of the organic compound, or may be bonded covalently via substituents having a valence of two or more. As the substituents having a valence of two or more, although not limited in particular, substituents having 0 to 10 carbons are preferable, and substituents containing no elements other than C, H, N, O, S and halogen as constituent elements are more preferable.

Examples of the group that is covalently bonded to the skeleton portion of the organic compound may include vinyl group, allyl group, methallyl group, acryl group, methacryl group, 2-hydroxy-3-(allyloxy)propyl group, 2-allylphenyl group, 3-allylphenyl group, 4-allylphenyl group, 2-(allyloxy)phenyl group, 3-(allyloxy)phenyl group, 4-(allyloxy)phenyl group, 2-(allyloxy)ethyl group, 2,2-bis(allyloxymethyl)butyl group, 3-allyloxy-2,2-bis(allyloxymethyl)propyl group.

It is also possible to use, as organic compounds, low molecular weight compounds which can hardly be described as two portions, namely a skeleton portion and a group having a carbon-carbon double-bond. Specific examples of the low molecular weight compound may include aliphatic chain polyene compounds such as butadiene, isoprene, octadiene and decadiene; aliphatic cyclic polyene compounds such as cyclopentadiene, cyclooctadiene, dicyclopentadiene, tricyclopentadiene and norbornadiene; and substituted aliphatic cyclic olefin compounds such as vinyl cyclopentene and vinyl cyclohexene.

From the viewpoint that heat resistance may be improved further, as the component (A), those containing at least 0.001 mol, more preferably at least 0.005 mol, furthermore preferably at least 0.008 mol, of carbon-carbon double-bonds having reactivity with a SiH group per 1 g of the component (A) are preferable.

In addition, while it is sufficient that the number of carbon-carbon double-bonds having reactivity with a SiH group is two per molecule of the component (A), from the viewpoint that heat resistance may be improved further, it is preferable that the number is more than 2. The number is more preferably at least 3, and particularly preferably at least 4. If the number is 1 or less per molecule, even if a reaction with the component (B) occurs, this leads only to a graft structure, and does not lead to a crosslinked structure. However, if the component (A) is a mixture of a variety of compounds, and the number of carbon-carbon double-bonds of each compound cannot be determined, the average number of carbon-carbon double-bonds per molecule is determined for the entirety of the mixture and used as the number of carbon-carbon double-bonds of the component (A).

As component (A), from the viewpoints that there is little stringiness of the raw material solution, uniform mixing with other components is possible, and handleability and coatability are satisfactory, those having fluidity at temperatures of 100° C. or lower are preferable.

While there is no particular restriction on the molecular weight of the component (A), a lower limit of 50 is preferable, 60 is more preferable, and 80 is furthermore preferable. An upper limit of 100,000 is preferable, 5,000 is more preferable, 2,000 is further preferable, 1,000 is even more preferable, 900 is even more preferable, 700 is even more preferable, and 500 is particularly preferable. Those with a molecular weight of lower than 50 tend to have large volatility, and those with a molecular weight exceeding 100,000 generally tend to result in raw materials with a high viscosity and poor workability.

In order to obtain uniform mixing with other components and satisfactory workability, components (A) having a viscosity at 23° C. of less than 3,000 Pa·s are preferable, of less than 1,000 Pa·s are more preferable, and of less than 100 Pa·s are furthermore preferable. The viscosity is a value measured with an E-type viscometer.

As specific examples of component (A), in addition to the above compounds, polydimethylsiloxanes, polydiphenylsiloxanes and polymethylphenylsiloxanes having a vinyl group as terminal group or side-chain group and random or block copolymers of two species or three species thereof, 1,3-divinyltetramethyl disiloxane, 1,3,5,7-tetravinyl cyclotetrasiloxane, diallylphthalate, triallyltrimellitate, diethyleneglycol bisallyl carbonate, trimethylol propane diallyl ether, pentaerythritol triallyl ether, 1,1,2,2-tetraallyloxy ethane, diallylidene pentaerythrit, triallyl cyanurate, triallyl isocyanurate, diallyl ether of 2,2-bis(4-hydroxycyclohexyl)propane, 1,2,4-trivinyl cyclohexane, divinyl benzenes (those with a purity of 50 to 100%, preferably those with a purity of 80 to 100%), divinyl biphenyl, 1,3-diisopropenyl benzene, 1,4-diisopropenyl benzene, oligomers thereof, 1,2-polybutadiene (those with a 1,2 ratio of 10 to 100%, and preferably those with a 1,2 ratio of 50 to 100%), allyl ether of novolac phenol, allylated polyphenylene oxide, epoxy resins in which a portion or the entirety of the glycidyl groups has been substituted by an allyl group,

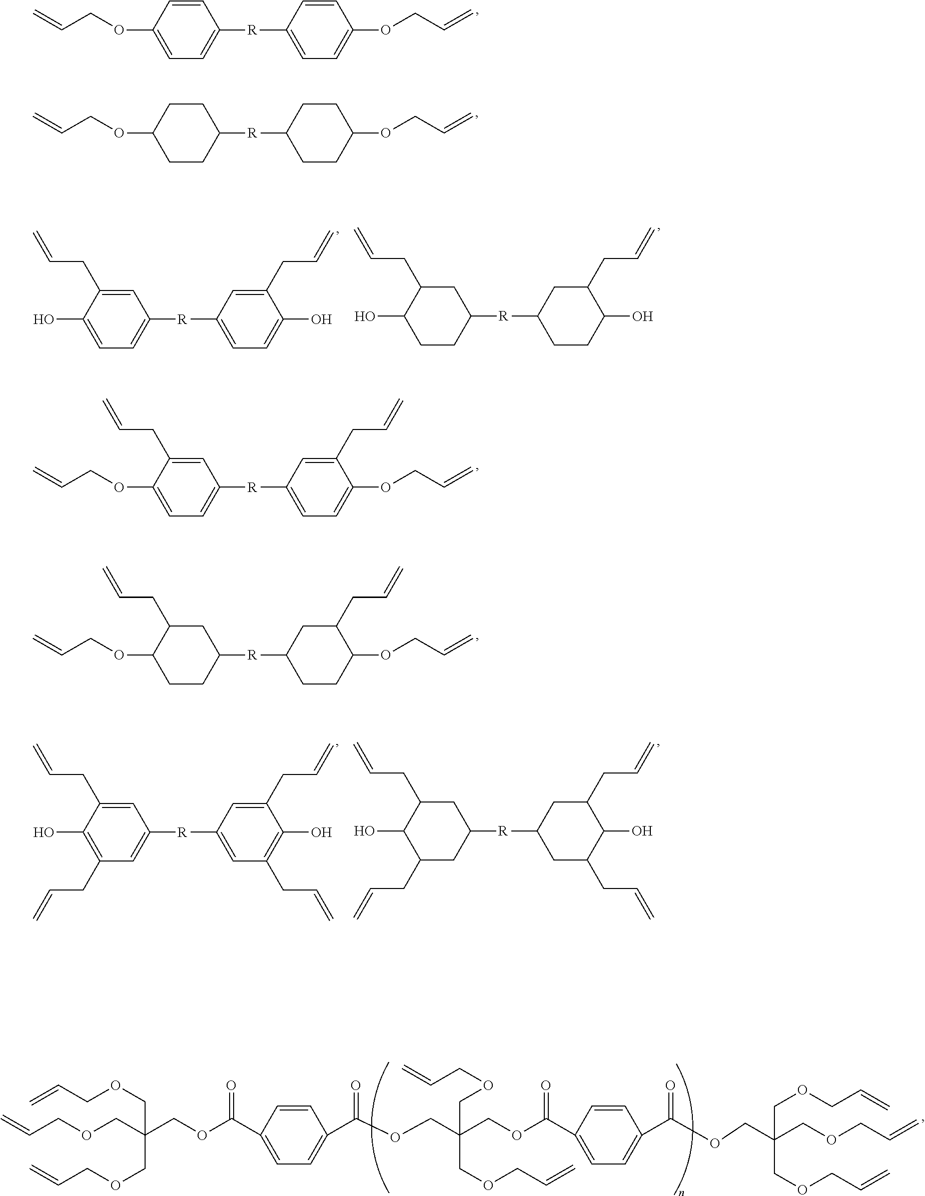

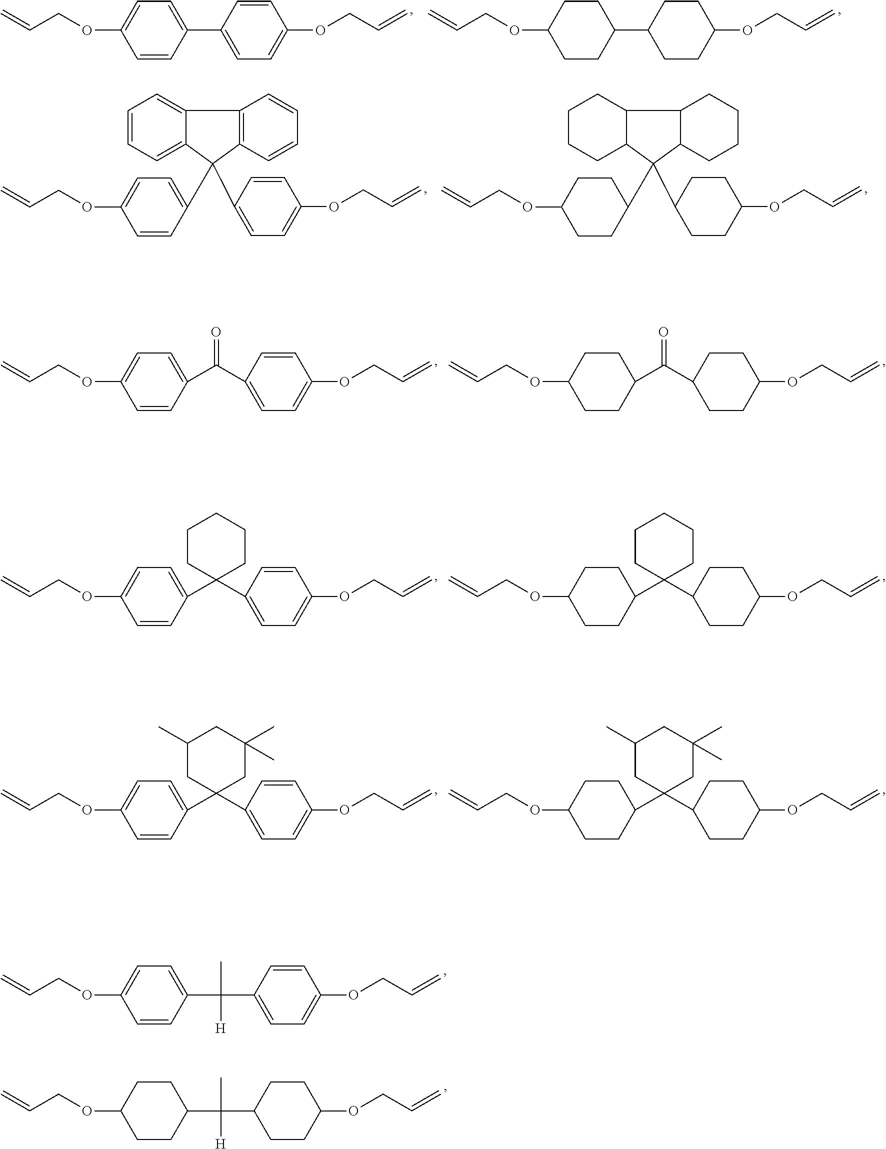

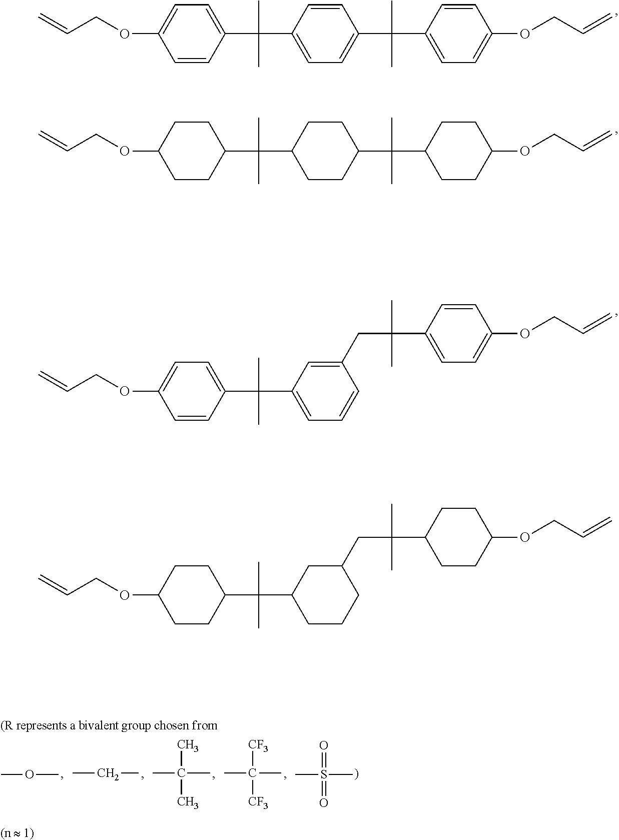

and the like, may be cited.

Among these, from the viewpoint that optical properties such as light resistance are excellent, those having an aromatic ring component weight ratio of 50% by weight or less within the component (A) are preferable, those having the ratio of 40% by weight or less are more preferable, and those having the ratio of 30% by weight or less are furthermore preferable. Most preferable are those that contain no aromatic hydrocarbon ring.

From the viewpoint that the obtained cured product has a high resistance to laser, compounds having a heterocyclic skeleton or an alicyclic skeleton are preferable. Examples of compounds having a heterocyclic skeleton may include the following general formula (4):

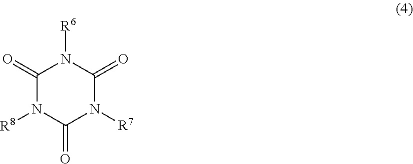

(wherein R⁶, R⁷ and R⁸ all represent organic groups, at least two of them being alkenyl groups). Examples of compounds having an alicyclic skeleton may include vinyl cyclohexene, dicyclopentadiene, 1,2,4-trivinyl cyclohexane and vinylnorbornene.

From the viewpoints of availability and reactivity, preferable as components (A) are bisphenol A diallyl ether, 2,2′-diallyl bisphenol A, allyl ether of novolac phenol, diallylphthalate, vinyl cyclohexene, divinyl benzene, divinyl biphenyl, triallyl isocyanurate, diallyl ether of 2,2-bis(4-hydroxycyclohexyl)propane and 1,2,4-trivinyl cyclohexane.

### [Component (B)]

The component (B) is not limited in particular as long as it is a compound containing in a molecule at least two SiH groups. For example, compounds described in WO96/15194 and having in a molecule at least two SiH groups can be used. A single compound may be used as component (B) or two or more compounds may be used in combination.

From the aspect of availability, the components (B) are preferably a chain and/or a cyclic organopolysiloxanes having in a molecule at least two SiH groups. Of these, from the viewpoint that compatibility with the component (A) is satisfactory, the cyclic polyorganosiloxanes having in a molecule at least two SiH groups represented by the following general formula (5)

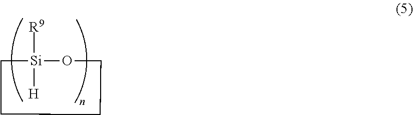

(wherein R⁹ represents an organic group having 1 to 6 carbons and n represents a number from 3 to 10) are more preferable. The substituent R⁹ within the compound represented by the general formula (5) is preferably a substituent containing no elements other than C, H and O, and is more preferably a hydrocarbon group.

In addition, from the viewpoint of compatibility, also preferable are compounds obtained by a hydrosilylation reaction of an organic compound (B-1) containing in a molecule at least two carbon-carbon double-bonds having reactivity with a SiH group and a silicon compound (B-2) having in a molecule at least two SiH groups. In this case, in order to further increase the compatibility of the reactant (reaction product) with the component (A), the reactant from which unreacted siloxanes or the like have been removed by volatilization or the like can also be used.

### [(B-1)]

The organic compound (B-1) is an organic compound containing in a molecule at least two carbon-carbon double-bonds having reactivity with a SiH group, and those same as the component (A) can also be used.

As organic compounds (B-1), from the points of view that there is little stringiness of the raw material solution, and handleability and coatability are satisfactory, those having fluidity at temperatures of 100° C. or lower are preferable.

The molecular weight of the organic compound (B-1) is preferably at least 50, more preferably at least 60, and furthermore preferably at least 80. In addition, it is preferably at most 100,000, more preferably at most 5,000, and furthermore preferably at most 2,000. Those with a molecular weight of lower than 50 tend to have large volatility, and those with a molecular weight exceeding 100,000 generally tend to result in raw materials with a high viscosity and poor workability.

In order to obtain uniform mixing with other components and satisfactory workability, organic compounds (B-1) having a viscosity at 23° C. of less than 3,000 Pa·s as are preferable, of less than 1,000 Pa·s are more preferable, and of less than 100 Pa·s are furthermore preferable. The viscosity is a value measured with an E-type viscometer.

From the viewpoint that the compatibility of the component (B) with respect to the component (A) is high, preferred specific examples of component (B-1) may include triallyl isocyanurate, allyl ether of novolac phenol, bisphenol A diallyl ether, 2,2′-diallyl bisphenol A, diallylphthalate, bis(2-allyloxyethyl)ester of phthalic acid, styrene,α-methyl styrene, allyl-terminated polypropylene oxide and polyethylene oxide, and the like. The organic compound of (B-1) component may be used alone, or two or more species may be used in combination.

From the viewpoint that the obtained cured product has a high resistance to laser, compounds having a heterocyclic skeleton or an alicyclic skeleton are preferable as organic compound (B-1). As compounds having a heterocyclic skeleton, for instance, compounds represented by the following general formula (1):

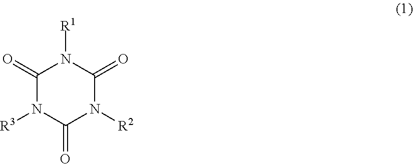

(wherein R¹, R² and R³ all represent organic groups, at least two of them being alkenyl groups) may be cited. As compounds having an alicyclic skeleton, for instance, vinyl cyclohexene, dicyclopentadiene, diallyl ether of 2,2-bis(4-hydroxycyclohexyl)propane, 1,2,4-trivinyl cyclohexane, vinylnorbornene, and the like, may be cited. Of these, from the viewpoint that optical properties are satisfactory, diallyl ether of 2,2-bis(4-hydroxycyclohexyl)propane, triallyl isocyanurate, and 1,2,4-trivinyl cyclohexane are more preferable, and triallyl isocyanurate is furthermore preferable.

### [(B-2)]

The silicon compound (B-2) is not particularly limited as long as it is a silicon compound containing at least two SiH groups in a molecule. For example, a compound described in WO96/15194′ and having in a molecule at least two hydrosilyl groups can be used. A single compound may be used as the compound (B-2) or a mixture of two or more may be used.

Among these, from the aspect of availability, a chain and/or cyclic organopolysiloxanes having in a molecule at least two hydrosilyl groups are preferable. From the viewpoint that the compatibility with respect to the component (A) of the component (B) obtained by a hydrosilylation reaction of the compound (B-2) and the organic compound (B-1) is adequate, cyclic organopolysiloxanes are preferable. Exampled of cyclic polysiloxanes containing hydrosilyl groups may include 1,3,5,7-tetramethyl cyclotetrasiloxane, 1-propyl-3,5,7-trihydrogen-1,3,5,7-tetramethyl cyclotetrasiloxane, 1,5-dihydrogen-3,7-dihexyl-1,3,5,7-tetramethyl cyclotetrasiloxane, 1,3,5-trihydrogen-1,3,5-trimethyl cyclosiloxane, 1,3,5,7,9-penta hydrogen-1,3,5,7,9-pentamethyl cyclosiloxane, and 1,3,5,7,9,11-hexahydrogen-1,3,5,7,9,11-hexamethyl cyclosiloxane. From the viewpoint of availability, 1,3,5,7-tetramethyl cyclotetrasiloxane is preferable.

While there is no particular restriction on the molecular weight of compound (B-2) and suitable ones can be used, from the viewpoint of handleability, those with a low molecular weight are preferable. In this case, the upper limit of the molecular weight is preferably 100,000, more preferably 1,000, and furthermore preferably 700.

Examples of the more preferable components (B) may include, from the viewpoint that optical properties are excellent, the product from a reaction of 1,3,5,7-tetramethyl cyclotetrasiloxane and vinyl cyclohexene, the product from a reaction of 1,3,5,7-tetramethyl cyclotetrasiloxane and dicyclopentadiene, the product from a reaction of 1,3,5,7-tetramethyl cyclotetrasiloxane and triallyl isocyanurate, the product from a reaction of 1,3,5,7-tetramethyl cyclotetrasiloxane and diallyl ether of 2,2-bis(4-hydroxycyclohexyl)propane, and the product from a reaction of 1,3,5,7-tetramethyl cyclotetrasiloxane and 1,2,4-trivinyl cyclohexane. Examples of particularly preferred components (B) include the product from a reaction of 1,3,5,7-tetramethyl cyclotetrasiloxane and triallyl isocyanurate, product from a reaction of 1,3,5,7-tetramethyl cyclotetrasiloxane and diallyl ether of 2,2-bis(4-hydroxycyclohexyl)propane, the product from a reaction of 1,3,5,7-tetramethyl cyclotetrasiloxane and 1,2,4-trivinyl cyclohexane and the like.

While the mixing ratio of the component (A) and component (B) is not particularly limited as long as the required strength is not lost, it is preferable that a ratio of the total number (Y) of SiH groups within the component (B) to the total number (X) of carbon-carbon double-bonds within the component (A) is within the range 2.0≧Y/X≧0.9, and the range 1.8≧Y/X≧1.0 is more preferable. If Y/X is over 2.0, sufficient curability cannot be obtained and in some cases sufficient strength cannot be obtained, and if Y/X is below 0.9, carbon-carbon double-bonds may be excessive, causing coloration.

In addition, concerning the total amount of component (A) and component (B) used, a volume ratio is preferably at least 5% by volume of the entirety of the composition, more preferably at least 10% by volume, and furthermore preferably at least 15% by volume. In addition, the volume ratio is preferably at most 50% by volume of the entirety of the composition, more preferably at most 40% by volume, and furthermore preferably at most 35% by volume. If it is less than 10% by volume, molding becomes difficult and the molded product tends to be fragile. In addition, if it is over 50% by volume, as the cure shrinkage during molding becomes large and the linear expansion coefficient of the molded product becomes high, it may become difficult to apply the molded product for semiconductor package.

### [Component (C)]

As the component (C), at least one species selected from the group consisting of α-alumina, hexagonal boron nitride, aluminum nitride and zinc oxide is used since heat resistance and electric insulation are excellent and also heat conductivity is increased. The component (C) may be used alone, or, from the viewpoint that those with different particle sizes can be used in combination, two or more species may be used in combination.

Among these, zinc oxide is particularly preferable from the viewpoint that, being a white pigment, it can raise the reflectance of the molded product.

From the viewpoint of mixing with the component (A) and the component (B), the component (C) is preferably a substance in powder form. In addition, it is preferable that, as much as possible, the component (C) does not contain as impurity a substance which inhibits the curing reaction wherein the component (A) and the component (B) are hydrosilylated.

Concerning the amount of heat-conductive filler used, from the viewpoint that the heat conductivity of the curable resin composition of the present invention can be raised, a volume ratio of heat-conductive filler at room temperature is preferably at least 5% by volume of the entirety of the composition, more preferably at least 10% by volume, further preferably at least 15% by volume, even more preferably at least 20% by volume, even more preferably at least 25% by volume, even more preferably at least 30% by volume, and even furthermore preferably at least 40% by volume. If it is less than 5% by volume, the heat-conductivity tends to become insufficient. In addition, a volume ratio is preferably at most 90% by volume of the entirety of the composition, more preferably at most 85% by volume, further preferably at most 80% by volume, even more preferably at most 75% by volume, and most preferably at most 65% by volume. If it is over 90% by volume, the strength of the material tends to decrease or the molding process may be difficult.

Here, the volume ratio of the heat-conductive filler is calculated from the respective weight fractions and the specific gravities of the resin portion and the heat-conductive filler, which is determined by the following formula. In the following formula, the heat-conductive filler is simply described as “filler”. In addition, the resin portion designates the entirety of the component except the heat-conductive filler.

Filler volume ratio (% by volume)=(filler weight ratio/filler specific gravity)/[(resin portion weight ratio/resin portion specific gravity)+(filler weight ratio/filler specific gravity)]×100

In addition, as one technique for raising the filling percentage of the heat-conductive filler with respect to the resin, it is favorable to use in combination two or more species of heat-conductive filler having different particle sizes. In this case, the ratio of particle size of the heat-conductive filler having a large particle size to that of the heat-conductive filler having a small particle size is preferably about 10/1.

There is no particular limitation on the shape of the heat-conductive filler, and a variety of shapes can be used, such as spherical, ellipse, plate, cube-shape, fiber-shape, quadrangular pyramid and star-shape. If higher filling of the heat-conductive filler is desired or if isotropic heat transmission is desired, it is preferable to use fillers which are spherical or round but close to spherical. Meanwhile, in such a case that high heat conductivity in the planar direction is desired, it is preferable to use fillers which are scale-shaped, plate-like or the like.

The heat-conductive fillers are particles wherein the primary particles have a number average particle diameter of at least 0.10 μm. Regarding the number average particle diameter, at least 0.20 μm is more preferable, at least 0.25 μm is further preferable, at least 0.30 μm is even more preferable, and at least 0.40 μm is most preferable. If the number average particle diameter is less than 0.10 μm, the specific surface area of the filler is large and dispersability tends to be low. Larger number average particle diameter provides larger heat conductivity or larger light reflectance of the resin composition. Moreover, larger number average particle diameter provides smaller bulk density of the powder, which enables addition of a large amount of powder to the resin. Nonetheless, the number average particle diameter is preferably at most 1 mm, more preferably at most 100 μm, and furthermore preferably at most 20 μm. If it is over 1 mm, there is a risk that molding processability is reduced.

The number average particle diameter of the primary particle of the heat-conductive filler is calculated by observing and photographing at least 100, preferably at least 1,000, powders with a scanning electron microscope, and measuring the particle diameter and the presence/absence of aggregates from the photograph. When a scale-shaped particle is observed in such a way that the projected surface area is broadest and the shape is circular, then the particle diameter is calculated from the diameter of the circle. In addition, when the shape is not circular, the longest dimension in the plane is referred to as the particle diameter. That is to say, the particle diameter of an elliptical shape is the major axis of the ellipse; that of a rectangle is the length of the diagonal line of the rectangle; and that of a needle-shape is the length in the longest direction, respectively. In case of, for instance, a fiber-shaped (cylinder-shaped) particle which cross-section diameter is 10 nm and length is 500 μm, the number average particle diameter of the primary particle is defined as 500 μm.

In addition, as one technique for raising the filling percentage of the heat-conductive filler with respect to the resin, as discussed above, it is favorable to use in combination two or more species of heat-conductive filler having different particle sizes. In this case, the ratio of particle size between the heat-conductive filler having a large particle size and the heat-conductive filler having a small particle size is preferably about 10/1. For instance, by using in combination heat-conductive filler particles having an average particle diameter of 5 μm and heat-conductive filler particles having an average particle diameter of 500 nm, the heat-conductive filler particles having an average particle diameter of 500 nm can fill the interstices in the heat-conductive filler particles having an average particle diameter of 5 μm, which can improve moldability and heat-conductivity. Incidentally, the particle diameter and the particle ratio are not limited to such examples, and a variety of combinations can be used.

From the viewpoint that dispersability in the resin improves, the heat-conductive filler may be the one which surface has been treated with: a silane coupling agent (vinylsilane, epoxysilane, (meth) acryl silane, isocyanate silane, chlorosilane, aminosilane or the like); or a titanate coupling agent (alkoxytitanate, aminotitanate or the like); or a fatty acid (saturated fatty acid such as caproic acid, caprylic acid, capric acid, lauric acid, myristic acid, palmitic acid, stearic acid or behenic acid; unsaturated fatty acid such as sorbic acid, elaidic acid, oleic acid, linoleic acid, linolenic acid or erucic acid; or the like); or a resin acid (abietic acid, pimaric acid, levopimaric acid, neoabietic acid, palustric acid, dehydroabietic acid, isopimaric acid, sandaracopimaric acid, columbic acid, secodehydroabietic acid, dihydroabietic acid or the like); or the like.

Zinc oxide is particularly preferable as the component (C) from the viewpoint that properties of resin composition such as whiteness, heat-conductivity, light reflectance, high strength, high elastic modulus and high viscosity can be conferred simultaneously.

It is preferable to use zinc oxide which per se has high heat conductivity. It is more preferable to use zinc oxide which, as a simple substance, has a heat conductivity of at least 30 W/mK.

Zinc oxide, active zinc oxide, zinc oxide grade 1 powder, zinc oxide grade 2 powder, zinc oxide grade 3 powder, zinc oxide whisker and the like can be preferably used as zinc oxides. Of these, zinc oxide grade 1 powder can be used preferably since it has little impurities and a large amount is available at a low cost.

While the particle shape of the zinc oxide particle is not defined in particular, a shape that is spherical or close to spherical is preferable as a shape in order to be included in the component (A) and the component (B) as much as possible.

### [Component (D)]

As for the hydrosilylation catalyst (D), there is no particular limitation as long as a catalytic activity for hydrosilylation reaction is present. As platinum compounds, for instance, platinum simple substance; solid platinum supported by a carrier such as alumina, silica or carbon black; chloroplatinic acid; complexes of chloroplatinic acid with an alcohol, an aldehyde or a ketone; platinum-olefin complexes (for instance, Pt(CH₂═CH₂)₂(PPh₃)₂ and Pt(CH₂═CH₂)₂Cl₂); platinum-vinylsiloxane complexes (for instance, Pt(ViMe₂SiOSiMe₂Vi)ₐ and Pt[(MeViSiO)₄]_{b}); platinum-phosphine complexes (for instance, Pt (PPh₃)₄ and Pt (PBu₃)₄); platinum-phosphite complexes (for instance, Pt[P (OPh)₃]₄ and Pt[P(OBu)₃]₄) (wherein Me represents a methyl group, Bu represents a butyl group, Vi represents a vinyl group and Ph represents a phenyl group, a and b represent integers); dicarbonyl dichloroplatinum; Karstedt catalyst; the platinum-hydrocarbon complexes described in the specifications of U.S. Pat. No. 3,159,601 and U.S. Pat. No. 3,159,662 by Ashby; the platinum alcoholate catalysts described in the specification of U.S. Pat. No. 3,220,972 by Lamoreaux, and the like, may be cited. In addition, the platinum chloride-olefin complexes described in the specification of U.S. Pat. No. 3,516,946 by Modic are also useful in the present invention.

Examples of hydrosilylation catalyst other than platinum compounds may include RhCl (PPh₃)₃, RhCl₃, RhAl₂O₃, RuCl₃, IrCl₃, FeCl₃, AlCl₃, PdCl₂.2H₂O, NiCl₂, and TiCl₄.

Among these, chloroplatinic acid, platinum-olefin complexes, platinum-vinylsiloxane complexes, and the like, are preferable from the viewpoint of catalytic activity. The hydrosilylation catalysts may be used alone, or two or more species may be used in combination.

Although the amount of hydrosilylation catalyst added is not limited in particular, it is preferably at least 10⁻⁸ moles, more preferably 10⁻⁶ moles, with respect to 1 mole of SiH group in the component (B) in order to confer sufficient curability and to keep the costs of the composition for optical materials comparatively low. In addition, it is preferably at most 10⁻¹ moles, and more preferably at most 10⁻² moles.

In addition, a co-catalyst can be used in combination with the above catalyst. Examples of co-catalyst may include phosphorous compounds such as triphenyl phosphine, 1,2-diester compounds such as dimethyl malate, acetylene alcohol compounds such as 2-hydroxy-2-methyl-1-butyne, sulfur compounds such as sulfur simple substance, amine compounds such as triethylamine, and water.

Although the amount of co-catalyst to be added is not particularly limited, with respect to 1 mole of hydrosilylation catalyst, a lower limit of at least 10⁻⁵ moles is preferable, and at least 10⁻³ moles is more preferable. In addition, at most 10² moles is preferable, and at most 10 moles is more preferable.

### [Other Additives]

Various additives other than those discussed above may be used in the curable resin composition of the present invention.

### [Filler]

Various fillers other than the above heat-conductive fillers may be used as necessary to an extent that does not impede the effects of the heat-conductive filler. As various fillers other than the heat-conductive fillers, although not limited in particular, reinforcing fillers such as wood powder, pulp, cotton chip, asbestos, mica, walnut shell powder, rice husk powder, diatomaceous earth, white clay, silica (fumed silica, precipitated silica, fused silica, dolomite, anhydrous silicic acid, hydrous silicic acid, amorphous spherical silica and the like), barium sulfate and carbon black; fillers such as diatomaceous earth, sintered clay, clay, talc, titanium oxide, bentonite, organic bentonite, ferric oxide, aluminum fine powder, flint powder, active zinc oxide, zinc powder, zinc carbonate and shirasu balloon, glass microballoon, organic microballoon of phenol resin or vinylidene chloride resin, and resin powders such as PVC powder and PMMA powder; fibrous fillers such as asbestos, glass fiber and glass filament, carbon fiber, Kevlar fiber and polyethylene fiber, various fluorescence substances, and the like, may be cited. Of these fillers, precipitated silica, fumed silica, fused silica, crystalline silica, ultrafine powder amorphous silica, hydrophobic ultrafine powder silica, talc, barium sulfate, fluorescence substances, dolomite, carbon black, titanium oxide, and the like, are preferable. Among these fillers, some slightly function as heat-conductive fillers, and in addition, similarly to carbon fiber, various metal powders, various metal oxides and various organic fibers, some can be used as excellent heat-conductive fillers depending on the composition, synthesis method, degree of crystallinity and crystal structure.

As methods for adding a filler, for instance, the method whereby a hydrolysable silane monomer or oligomer such as alkoxysilane, acyloxysilane or halogenated silane, or an alkoxide, an acyloxide or a halide of a metal such as titanium or aluminum, and the like, is added to the curable composition of the present invention and reacted within the composition or within a partial reactant of the composition to generate an inorganic filler within the composition can also be cited.

It is preferable to use the above fillers in combination when zinc oxide is used as the heat-conductive filler since there are possibilities that insulation property drops when a large amount thereof is added, and in addition, that the light resistance drops due to a photocatalytic activity of the zinc oxide. In this case, the above various silicas are particularly preferable as fillers.

In addition, in order to raise the filling percentage with respect to the resin, the particle sizes of zinc oxide and silica are preferably different. In this case, from the viewpoint of costs, it is preferable to use in combination zinc oxide having a small particle size and silica having a large particle size, the particle size ratio thereof being preferably about 1/10 at most. If the particle size of silica is excessively large with respect to the particle size of zinc oxide, there is a possibility that the filling percentage is low. Since heat conductivity is higher if the particle size of zinc oxide is larger, zinc oxide having a large particle size and silica having a small particle size may be used in combination. Also in this case, in order to raise the filling percentage, a particle size ratio is preferably about 10/1 at most.

### [Silane Coupling Agent]

A silane coupling agent can also be added to the curable resin composition to improve adhesive property with the substrate or the like. In addition, the effect of improving the adherence at the interface between the (A) and components (B) and the (C) component is obtained by adding a silane coupling agent.

The silane coupling agents is not limited in particular as long as it is a compound having within the molecule at least one each of a functional group having reactivity with an organic group and a hydrolysable silicon group. As functional group having reactivity with an organic group, at least one functional group selected from the group consisting of epoxy group, methacryl group, acryl group, isocyanate group, isocyanurate group, vinyl group and carbamate group is preferable from the viewpoint of handleability, and epoxy group, methacryl group and acryl group are particularly preferable from the viewpoint of curability and adhesive property. As hydrolysable silicon group, alkoxysilyl group is preferable from the viewpoint of handleability, and methoxysilyl group and ethoxysilyl group are particularly preferable from the viewpoint of reactivity.

Examples of preferred silane coupling agents include: alkoxysilanes having an epoxy functional group such as 3-glycidoxypropyl trimethoxysilane, 3-glycidoxypropyl triethoxysilane, 2-(3,4-epoxycyclohexyl)ethyl trimethoxysilane and 2-(3,4-epoxycyclohexyl)ethyl triethoxysilane; and alkoxysilanes having a methacryl group or an acryl group such as 3-methacryloxypropyl trimethoxysilane, 3-methacryloxypropyl triethoxysilane, 3-acryloxypropyl trimethoxysilane, 3-acryloxypropyl triethoxysilane, methacryloxymethyl trimethoxysilane, methacryloxymethyl triethoxysilane, acryloxymethyl trimethoxysilane and acryloxymethyl triethoxysilane.

The amount of silane coupling agent to be added is preferably at least 0.1 parts by weight with respect to 100 parts by weight of [component (A)+component (B)+(C) component], and more preferably at least 0.5 parts by weight. In addition, it is preferably at most 50 parts by weight, and is more preferably at most 25 parts by weight. If it is less than 0.5 parts by weight, it may be hard to obtain the effect of adhesiveness improvement, and if it is over 50 parts by weight, there is a possibility of adverse effects on the physical properties of the cured product.

The silane coupling agent may be added directly to the component (A) and the component (B), or may be added to the component(C) beforehand and briefly mixed, and then the component (C) treated with the silane coupling agent may be added to the component (A) and the component (B). Alternatively, the component (C) that has been pre-treated with a silane coupling agent can be obtained as a commercially available product.

### [Silanol Condensation Catalyst]

For the purpose of further improving the adhesive property of the curable resin composition of the present invention toward the substrate, a silanol condensation catalyst can be used. Specific examples of silanol condensation catalysts which can be used are not particularly limited, and include tri-2-ethylhexyl borate, tri-n-octadecyl borate, tri-n-octyl borate, triphenyl borate, trimethylene borate, tris(trimethylsilyl) borate, tri-n-butyl borate, tri-sec-butyl borate, tri-tert-butyl borate, triisopropyl borate, tri-n-propyl borate, triallyl borate, triethyl borate, trimethyl borate, boron methoxyethoxide, and the like, can be used suitably.

### [Curing Retardant]

For the purpose of improving the storage stability of the curable resin composition of the present invention or for the purpose of adjusting the reactivity of the hydrosilylation reaction in the preparation process, a curing retardant can be used. Examples of curing retardants include compounds containing an aliphatic unsaturated bond, organophosphorous compounds, organosulfur compounds, nitrogen-containing compounds, tin compounds and organic peroxides. These may be used alone, or two or more species may be used in combination.

Examples of compounds containing an aliphatic unsaturated bond include propargyl alcohols, ene-yne compounds and maleates. Examples of organophosphorous compounds include triorganophosphines, diorganophosphines, organophosphones and triorganophosphites. Examples of organosulfur compounds include organomercaptans, diorganosulfides, hydrogen sulfide, benzothiazole, thiazole and benzothiazole disulfide. Examples of nitrogen-containing compounds include ammonia, primary, secondary or tertiary alkyl amines, aryl amines, urea and hydrazine. Examples of tin compounds include stannous halide dihydrate and stannous carboxylate. Examples of organic peroxides include di-tert-butyl peroxide, dicumyl peroxide, benzoyl peroxide and tert-butyl peroxybenzoate.

Among these curing retardants, from the viewpoints that retardation activity is satisfactory and materials are readily obtained, benzothiazole, thiazole, dimethyl malate, 3-hydroxy-3-methyl-1-butyne and 1-ethinyl-1-cyclohexanol are preferable.

The amount of curing retardant to be added is preferably at least 10⁻¹ moles with respect to 1 mole of hydrosilylation catalyst, and more preferably at least 1 mole. In addition, it is preferably at most 10³ moles, and more preferably at most 50 moles.

### [Resin]

For the purpose of modifying the properties of the curable resin composition of the present invention, a variety of resins can be added. As the resins, polycarbonate resin, polyether sulfone resin, polyallylate resin, epoxy resin, cyanate resin, phenol resin, acryl resin, polyimide resin, polyvinyl acetal resin, urethane resin, polyester resin, and the like, are indicated as examples, with no limitation to these.

### [Anti-aging Agent]

An anti-aging agent may be added to curable resin composition of the present invention. Examples of anti-aging agents include, in addition to anti-aging agents generally used such as hindered phenolic anti-aging agents, citric acid, phosphoric acid and sulfuric anti-aging agents.

To begin with Irganox 1010 available from BASF Japan, various agents are used as hindered phenolic anti-aging agents.

As sulfuric anti-aging agents, mercaptans, mercaptan salts, sulfides including sulfide carboxylate esters and hindered phenol sulfides, polysulfides, dithiocarboxylic acid salts, thioureas, thiophosphates, sulfonium compounds, thioaldehydes, thioketones, mercaptals, mercaptols, monothio acids, polythio acids, thio amides, sulfoxides, and the like, may be cited.

These anti-aging agents may be used alone, or may be used by combining two or more species.

### [Radical Inhibitor]

A radical inhibitor may be added to the curable resin composition of the present invention. Examples of radical inhibitors include phenolic radical inhibitors such as 2,6-di-t-butyl-4-methyl phenol (BHT), 2,2′-methylene-bis(4-methyl-6-t-butylphenol) and tetrakis [methylene-3-(3,5-di-tert-butyl-4-hydroxyphenyl) pro pionate]methane; and amine radical inhibitors such as phenyl-β-naphthyl amine, α-naphthyl amine, N,N′-sec-butyl-p-phenylene diamine, phenothiazine and N,N′-diphenyl-p-phenylene diamine.

These radical inhibitors may be used alone, or may be used by combining two or more species.

### [Ultraviolet Absorber]

An ultraviolet absorber may be added to the curable resin composition of the present invention. Examples of ultraviolet absorbers include 2 (2′-hydroxy-3′, 5′-di-t-butyl phenyl) benzotriazole, and bis(2,2, 6, 6-tetramethyl-4-piperidine) sebacate.

These ultraviolet absorbers may be used alone, or may be used by combining two or more species.

In addition, a flame retardant, a flame retardant aid, a surfactant, an antifoaming agent, an emulsifying agent, a leveling agent, an anti-cissing agent, an ion-trapping agent such as antimony-bismuth, a thixotropic agent, a tackifier, an antiozonant, a light stabilizer, a thickener, a plasticizer, an antioxidant, a heat stabilizer, a processing stabilizer, a reactive diluent, an antistatic agent, an electrical conductivity-imparting agent, a radiation-blocking agent, a nucleating agent, a phosphorous peroxide decomposing agent, a mold-releasing agent, a dispersant, a compatibilizing agent, an antibacterial agent, a lubricant, a pigment, a dye, a metal inactivator, an adhesion promoter, a physical property adjuster, a stabilization aid, or the like, can be added to the curable resin composition of the present invention to an extent that does not impede the object and effects of the present invention.

### [Curable Resin Composition Preparation Method]

The preparation method for the curable resin composition of the present invention is not limited in particular. Preparation is possible, for instance, by drying the components, additives and the like described above and then kneading them with a kneader such as a single screw extruder or a twin screw extruder. In addition, preparation is also possible, if a mixing component is a liquid, by adding the component to the kneader during the kneading using a liquid supply pump or the like. Otherwise, preparation is also possible by supplying each prescribed component to a Banbury mixer, a kneader, a roll, a feeder ruder, or the like, and kneading. The supply method for each component is not limited in particular, and the respective components may be mixed at once and kneaded or may be fractionally mixed in multiple stages and kneaded. It is preferable to remove the volatile fraction, which generates bubbles upon curing, by vacuum volatilization or the like prior to curing.

With regard to the curable resin composition of the present invention, the mixture of each component and additives and the like may be used as-is, or may be used once partially reacted (B-staged) by heating or the like. B-staging enables viscosity adjustment, and also allows adjustment of moldability during transfer molding.

### [Composition Characteristics]

As the curable resin composition of the present invention, while those from various combinations can be used as described above, those having fluidity at temperatures of 150° C. or lower are preferable from the viewpoint that moldability by transfer molding or the like is satisfactory.

While curability of the composition can be arbitrarily adjusted, on the viewpoint that the molding cycle can be shortened, a gelling time falling within 120 seconds at 120° C. is preferable, and within 60 seconds is more preferable. In addition, a gelling time falling within 60 seconds at 150° C. is preferable, and within 30 seconds is more preferable. In addition, a gelling time falling within 180 seconds at 100° C. is preferable, and within 120 seconds is more preferable. Here, the gelling time is measured by placing a 50 μm-thick aluminum foil on a hot plate adjusted to the setting temperature, placing 100 mg of composition on this, and measuring the time until gelling.

From the viewpoint that, in the manufacturing process in which the composition is used, processing problems caused by the occurrence of voids in the composition and outgassing from the composition are unlikely to occur, it is preferable that the curable resin composition of the present invention has a weight loss during curing of at most 5% by weight, and at most 3% by weight is more preferable, and at most 1% or less is furthermore preferable. The weight loss during curing can be determined by heating 10 mg of sealant from room temperature to 150° C. at a rate of temperature increase of 10° C./min by using a thermogravimetric analyzer, and the ratio of the deducted weight to the initial weight is defined as the weight loss. From the viewpoint that they are unlikely to provoke the problem of silicone contamination when used as an electronic material or the like, those which has the Si atom content in the volatile components of 1% or less are preferable.

### [Curing Method]

The curable resin composition of the present invention can be cured by pre-mixing and reacting by hydrosilylation a portion or the entirety of the SiH groups in the composition with carbon-carbon double-bonds having reactivity with the SiH group.

When reacting and curing the composition, while the required amounts of the components (A), (B) and (C) and the other respective components may be mixed at once and reacted, the process comprising mixing a portion and carrying out a reaction and then mixing the remainder and further carrying out a reaction, or the process comprising mixing the components, thereafter carrying out a reaction of only a portion of the functional groups in the composition (B-staging) via a control of the reaction conditions or the utilization of differences in the reactivities of the substituents, and then further curing via a step such as molding can also be adopted. These processes facilitate adjustment of viscosity at molding.

Concerning the curing methods, it is possible to carry out the reaction by merely mixing components or also by heating. From the viewpoint that the reaction is rapid and that generally materials having high heat resistance are readily obtained, reaction by heating is preferable.

Concerning curing temperature, while a variety of settings are possible, at least 30° C. is preferable, at least 100° C. is more preferable, and at most 300° C. is preferable, and at most 200° is more preferable. If the reaction temperature is less than 30° C., the reaction time required for sufficient reaction tends to increase, and if the reaction temperature is higher than 300° C., there is a possibility that the molding processing becomes difficult.

While curing can be carried out at constant temperature, the temperature may be varied stepwise or continuously as necessary. Rather than a reaction at a constant temperature, a reaction at temperatures which increase stepwise or continuously is preferable from the viewpoint that a distortion-free, homogenous cured product is readily obtained. Curing at a constant temperature is preferable from the viewpoint that the molding cycle can be shortened.

While a variety of settings are also acceptable for the curing time, rather than a short time reaction at a high temperature, a long time reaction at a comparatively low temperature is preferable from the viewpoint that a distortion-free, homogenous cured product is readily obtained. On the other hand, a short time reaction at a high temperature is preferable from the viewpoint that the molding cycle can be shortened. A variety of settings are also acceptable for the pressure during reaction as necessary, and reactions can be carried out in an ordinary pressure, a high pressure, or a reduced pressure state. Curing in a reduced pressure state is preferable from the viewpoint that it is easy to remove volatile fractions, which are produced depending on the circumstances. From the viewpoint that cracks in the molded product can be prevented, curing in a pressurized state is preferable.

### [Heat-conductive Resin Molded Product]

The heat-conductive resin molded product of the present invention is obtained by curing a curable resin composition via a hydrosilylation reaction as discussed above.

Various methods are used for forming the heat-conductive resin molded product. For instance, various molding methods generally used for thermosetting resins such as injection molding, transfer molding, RIM molding, casting molding and press molding are used. Of these, transfer molding is preferable from the viewpoints that the molding cycle is short and moldability is satisfactory. While molding conditions, the molding temperature for instance, can also be set arbitrarily, the molding temperature of at least 100° C. is preferable, at least 120° C. is more preferable, and at least 150° C. is furthermore preferable, from the viewpoints that rapid curing, short molding cycle and satisfactory moldability are facilitated. As necessary, it is also optional to carry out post-curing (after-curing) after molding by various methods as described above. Performing post-curing aids the heat resistance to increase.

### [Characteristics of Heat-conductive Resin Molded Product]

From the viewpoint that the heat resistance is satisfactory, the cured product (heat-conductive resin molded product), obtained by curing the curable resin composition, which has Tg of at least 100° C. is preferable, and the one which has Tg of at least 150° C. is more preferable. Here, the peak temperature of tan δ obtained in a dynamic viscoelasticity measurement (using DVA-200 manufactured by IT Keisoku Seigyo Corporation) using a 3 mm×5 mm×30 mm prismatic sample, under the conditions of: tensile mode; measurement frequency of 10 Hz; distortion of 0.1%; static/dynamic force ratio of 1.5; and temperature increase rate of 5° C./min, is defined as Tg.

In addition, from the points of view that problems such as ion migration to the lead frame are unlikely and reliability is improved, extracted ion contents from the cured product is preferably less than 10 ppm, more preferably less than 5 ppm, and furthermore preferably less than 1 ppm.

In this case, the extracted ion contents are investigated in the following manner.

With 50 mL of ultrapure water, 1 g of cut cured product is introduced into a Teflon (registered trademark) container, which is then sealed, and treated under the conditions of 121° C., 2 atm. and 20 hours. The obtained extract is analyzed by ICP mass spectrometry (using HP-4500 manufactured by Yokogawa Analytical Systems, Inc.), and the values of the contents of Na and K obtained are converted into concentrations in the cured product used. Meanwhile, the same extract is analyzed by ion chromatography (using DX-500 manufactured by Nippon Dionex K.K.; column: AS12-SC), and the values of the contents of Cl and Br obtained are converted into concentrations in the cured product used. The contents of Na, K, Cl and Br in the cured product thus obtained are summed, and defined as the extracted ion contents.

As for the color of the cured product, although various ones are used, a color which attains a high reflectance of the package is preferable since light extraction efficiency is excellent, and white is furthermore preferable. When a light-emitting diode is used in a display device, black is preferable from the viewpoint that the contrast readily becomes high.

As for the linear expansion coefficient of the cured product, although there is no particular limitation, from the viewpoint that the adhesiveness to metal such as a lead frame or ceramics or the like, readily becomes satisfactory, a linear expansion coefficient at 100° C. of at most 50 ppm is preferable, and at most 30 ppm is more preferable. In addition, from the viewpoint that the adhesiveness to organic materials such as a sealing resin readily becomes satisfactory, a linear expansion coefficient at 100° C. of at least 70 ppm is preferable, and at least 100 ppm is more preferable. In addition, from the viewpoints that a stress between the package and the sealant is unlikely to occur during curing, after curing and during heat-tests and reliability readily improves, it is preferable that the cured product has a linear expansion coefficient close to that of the sealant and that the linear expansion coefficient is temperature-dependent.

The heat-conductive resin molded product of the present invention is preferably highly heat-conductive in order to transmit heat efficiently. The heat conductivity is at least 0.8 W/mK, and is more preferably at least 0.9 W/mK, is further preferably at least 1.0 W/mK, and is most preferably at least 1.2 W/mK. In addition, it is preferably at most 10,000 W/mK, is more preferably at most 9,000 W/mK, is further preferably at most 8,000 W/mK, and is most preferably at most 5,000 W/mK. By using such highly heat-conductive materials, the temperature of the heat-generating portion becomes uniform, and the temperature of the heat-generating center drops.

As for the light reflectance at the wavelength of 450 nm of the heat-conductive resin molded product, an initial value of at least 75% is preferable, at least 80% is more preferable, and at least 85% is most preferable. If the reflectance is less than 75%, problems sometimes occur, that the time of use becomes short when the molded product is used as a case for an LED semiconductor element. When the molded product is used in optical components, in semiconductor packages to begin with, it is preferable that the initial reflectance is at least 85%.

Furthermore, as for the light reflectance after a 180° C., 24 hour-degradation test, an initial value of at least 75% is preferable, at least 80% is more preferable, and at least 85% is most preferable. In addition, as for the light reflectance at the wavelength of 450 nm after irradiating the cured product for 24 hours (60 mW/cm) using a high pressure mercury lamp of 365 nm peak wavelength, an initial value of at least 75% is preferable, at least 80% is more preferable, and at least 85% is most preferable.

### [Applications of the Heat-conductive Resin Molded Product]

The heat-conductive resin molded product of the present invention can be used suitably as an optical component, a semiconductor package to begin with, an electronic component, a semiconductor substrate or the like.

### [Semiconductor Package]

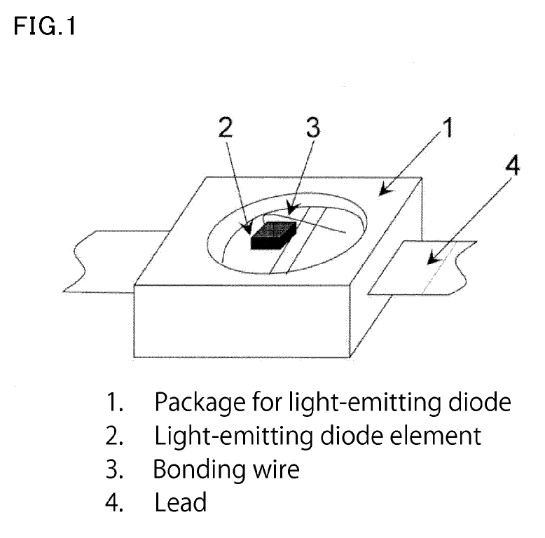

The semiconductor package mentioned above is a member provided in order to support and immobilize and/or protect a semiconductor element and/or a lead-out electrode or the like. Examples of semiconductor elements in this case include integrated circuits such as ICs and LSIs, elements such as transistors, diodes and light-emitting diodes, and light-receiving elements such as CCDs. Of these semiconductors, those which have large heat generation, such as, for instance, light-emitting diodes, are preferable since the effects of the present invention may become more remarkable. In addition, when the semiconductor is a light-emitting diode element, those designed so as to radiate the light exiting from the light-emitting diode element are preferable, and those designed so as to reflect the light exiting from the light-emitting diode element and lead it outside are more preferable. In this case, the effect may become remarkable if the whiteness of the package is at least 80. There is no particular restriction on the shape or the like of the semiconductor package. For instance, as the light-emitting diode package of FIG. 1, one may have a shape having a concave portion in order to mount the light-emitting diode element 2, or one may be simply in a flat plate shape. The surface of the semiconductor package may be smooth, or may have a surface that is not smooth such as embossed.

### [Applications of Semiconductor Package]

A semiconductor package using the light-emitting diode can be used in various applications that are well known in the art. Concretely, for instance, it can be used for backlight for a liquid crystal display device or the like, lighting device, sensor light source, vehicle instrument light source, signaling light, indicator light, indicating device, light source of a planar light-emitter, display, ornament, various lights, and the like.

### [Light-emitting Diode Element]

As for light-emitting diode elements, light-emitting diode elements well known in the art that are used in light-emitting diodes can be used with no particular restriction. The size and the number of the light-emitting diode element are also not particularly limited. One species of the light-emitting diode element may be used to emit monochromatic light, or a plurality of these may be used so as to emit monochromatic or polychromatic light.

### [Sealant for Semiconductor]

A semiconductor sealant is not particularly limited, and one species or two or more species in any combination, as necessary, may be selected from among various widely-known thermosetting resins and used. Meanwhile, sealing is also possible via hermetic seal by covering with glass or the like, without using a resin seal. Examples of resin seals include conventionally used epoxy resins, silicon thermosetting resins, cyanate resins, phenol resins, polyimide resins, polyurethane resins, acryl resins, urea resins and modified resins thereof, but are not limited to these. Among these, transparent epoxy resins, silicon thermosetting resins containing silicon in the molecule or transparent polyimide resins are preferable from the viewpoint that transparency is high and practical properties such as adhesive properties are excellent.

Examples of transparent epoxy resins include those obtained by curing an epoxy resin such as bisphenol A diglycidyl ether, 2,2′-bis(4-glycidyloxycyclohexyl)propane, 3,4-epoxycyclohexylmethyl-3,4-epoxycyclohexane carboxylate, vinylcyclohexene dioxide, 2-(3,4-epoxycyclohexyl)-5,5-spiro-(3,4-epoxycyclohexane)-1, 3-dioxane, bis(3,4-epoxycyclohexyl)adipate, 1,2-cyclopropane dicarboxylic acid bisglycidyl ester, triglycidyl isocyanurate, monoallyl diglycidyl isocyanurate or diallyl monoglycidyl isocyanurate with an aliphatic acid anhydride curing agent such as hexahydrophthalic anhydride, methyl hexahydrophthalic anhydride, trialkyl tetrahydrophthalic anhydride or hydrogenated methyl nadic acid anhydride. These epoxy resins or curing agents may be used alone respectively, or a plurality thereof may be combined.

As transparent polyimide resins, fluorine-containing polyimide resins may be cited.

Among the above thermosetting resins, silicon thermosetting resins are preferable from the viewpoint that resistance to weather, light-transmissibility, heat resistance and the like of the resin are excellent. As silicon thermosetting resins, silicone resins, modified silicone resins, epoxy group-containing silicone resins, curable resins comprising a cage-shaped silsesquioxane having a reactive functional group and the like may be cited.

Of the above silicon thermosetting resins, furthermore preferable are silicon thermosetting resins comprising an organic compound containing in a molecule at least two carbon-carbon double-bonds having reactivity with a SiH group, a silicon compound containing in a molecule at least two SiH groups, and a hydrosilylation catalyst. As each of the above components, the components used in the curable resin composition of the present invention can be used.

### [Temperature of the Heat-generating Center of the Semiconductor Package]

Herein, heat-generating center designates a portion that demonstrates the maximum value of temperature distribution during the use of semiconductor. The temperature of the heat-generating center is preferably at least −50° C., more preferably at least −40° C., and furthermore preferably at least 5° C. In addition, it is preferably at most 300° C., more preferably at most 250° C., and furthermore preferably at most 200° C. If it is less than −50° C., there is a possibility that the package is destroyed by the heat cycle. In addition, if it is over 300° C., the operation of the semiconductor element sometimes becomes slow or fails. In an electronic apparatus, the heatproof temperature of the semiconductor is sometimes limited to 120° C. or lower.

### [Electric Power Consumption of Semiconductor]

A portion of the electric power consumed by the semiconductor is turned into heat, which is a factor of degradation. Generally, half or more of the consumed electric power is turned into heat. The more the semiconductor consumes the electric power, the more the heat is generated. Herein, the electric power consumption of the semiconductor is at least 0 W, and is preferably at least 0.001 W, and more preferably at least 0.004 W. In addition, it is preferably at most 100 W, more preferably at most 90 W, and furthermore preferably at most 50 W. When the electric power consumption of the semiconductor is less than 0.001 W, the temperature rise is small, which is manageable even with a conventional package. Meanwhile, when the electric power consumption of the semiconductor is greater than 100 W, it is hard to sufficiently let the heat away and there is a possibility the temperature rises so as to exceed the heatproof temperature of the semiconductor.

### [Semiconductor Lead]

As lead terminals used in the semiconductor package according to the present invention (for instance 4 in FIG. 1), those which have satisfactory adhesiveness to an electric connection member such as a bonding wire (for instance, 3 in FIG. 1), electric conductivity, and the like, are preferable. The electric resistance of the lead terminal is preferably at most 300 μΩ·cm, and more preferably at most 3 μΩ·cm. Examples of materials for these lead terminals include iron, copper, iron-containing copper, tin-containing copper, and these with gold, silver, nickel, palladium or the like plated thereon. The glossiness of these lead terminals may be adjusted suitably so as to obtain a satisfactory light spread.

### EXAMPLES

Hereinafter, the present invention will be described in further details by means of examples. However, the present invention is not limited to these examples alone.

In the examples, the followings were used as fillers:

### (Heat-Conductive Filler)

Zinc oxide (manufactured by Sakai Chemical Industry Co., Ltd.; zinc oxide grade 1; specific gravity: 5.6; number average particle diameter of the primary particle: 0.6 μm)
Zinc oxide (manufactured by Sakai Chemical Industry Co., Ltd.; LPZINC-5; specific gravity: 5.6; number average particle diameter of the primary particle: 5 μm)
Round alumina (manufactured by Showa Denko K.K.; AS-40; specific gravity: 3.9; average particle size: 12 μm)
Spherical alumina (manufactured by DENKI KAGAKU KOGYO KABUSHIKI KAISHA; ASFP-20; specific gravity: 3.9; average particle size: 0.2 μm)
Hexagonal boron nitride (manufactured by MIZUSHIMA FERROALLOY CO., LTD; HP-40; specific gravity: 2.3; average particle size: 7 μm)
Spherical hexagonal boron nitride (manufactured by DENKI KAGAKU KOGYO KABUSHIKI KAISHA; SGPS; average particle size: 12 μm)

### (Other Fillers)

Titanium oxide (manufactured by ISHIHARA SANGYO KAISHA, LTD; Tipaque PC-3; rutile type; specific gravity: 4.2; organically surface treated; average particle size: 0.21 μm)
Titanium oxide (manufactured by ISHIHARA SANGYO KAISHA, LTD; Tipaque R820)
Spherical silica (manufactured by TATSUMORI LTD.; MSR-3500; specific gravity: 2.2; average particle size: 37 μm)
Spherical silica (manufactured by Admatechs Company Limited; Admafine S0-C2; specific gravity: 2.2; average particle size: 0.5 μm)

### Synthesis Example 1

A stirrer, a drip funnel and a condenser were set to a four-necked 5 L-flask. To this flask were introduced 1,800 g of toluene and 1,440 g of 1,3,5,7-tetramethyl cyclotetrasiloxane, which were then heated and stirred in an oil bath at 120° C. A mixed solution of 200 g of triallyl isocyanurate, 200 g of toluene and 1.44 mL of a xylene solution of platinum vinylsiloxane complex (containing 3% by weight of platinum) was added dropwise over 50 minutes. The obtained solution was heated and stirred as is for 6 hours, and then, unreacted 1,3,5,7-tetramethyl cyclotetrasiloxane and toluene were evaporated under reduced pressure.

It was found by ¹H-NMR that the product was a mixture containing, as the main component, the following (referred to as reactant A) which is a compound obtained by reacting a portion of the SiH groups of 1,3,5,7-tetramethyl cyclotetrasiloxane with the allyl groups of triallyl isocyanurate. In addition, when the SiH group content was determined by ¹H-NMR using 1,2-dibromomethane as the internal standard, it was found that 8.08 mmol/g of SiH groups was contained. In addition, this mixture contained the platinum vinylsiloxane complex, the component (D).

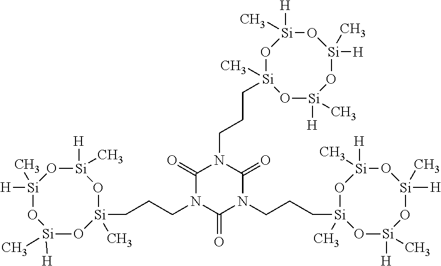

### Synthesis Example 2

To a 5 L-separable flask were added 1.44 kg of 1,3,5,7-tetramethyl cyclotetrasiloxane, 200 g of triallyl isocyanurate and 1.44 mL of a xylene solution of platinum vinylsiloxane complex (containing 3% by weight of platinum) and mixed to obtain an uncured sealant mixture 1.

### Example 1

Mixed were 20.00 g of triallyl isocyanurate as component (A), 29.78 g of the product obtained in Synthesis Example 1 as component (B), 0.0251 g of a xylene solution of platinum vinylsiloxane complex (containing 3% by weight of platinum) as component (D) and 0.147 g of 1-ethinyl-1-cyclohexanol. Added thereto were 24.98 g of titanium oxide (manufactured by ISHIHARA SANGYO KAISHA, LTD; Tipaque R820) and 499.6 g of round alumina (manufactured by Showa Denko K.K.; AS-40) as component (C), and were kneaded three times with three ceramic rolls to obtain a curable resin composition. It was in a paste-form which was hard at room temperature, but when a small amount was placed on a hot plate heated to 150° C., the viscosity dropped temporarily and it turned into a fluid state and gelled in 40 seconds.

A transfer molding machine model MF-0 manufactured by Marushichiseisakujo Co., Ltd was used to perform transfer molding of this curable resin composition. Using a mold for six 10 mm×10 mm×3 mm samples, satisfactory molded products with no flash, crack, void or the like, were obtained when molding was performed under the conditions: raw material pot temperature: room temperature; mold temperature: 150° C.; molding pressure: 70 kgf/cm²; and molding time: 60 seconds.

In addition, using a mold for four cylindrical 21 mmφ×6.4 mm samples, satisfactory molded products with no flash, crack, void or the like were obtained when molding was performed under the conditions: raw material pot temperature: room temperature; mold temperature: 140° C.; molding pressure: 70 kgf/cm²; and molding time: 120 seconds. The obtained molded product was post-cured by heating under air inside a hot air-circulating oven at 150° C. for one hour to obtain a white cured product. When the heat-conductivity of the cured product was measured, it was 1.4 W/mK.

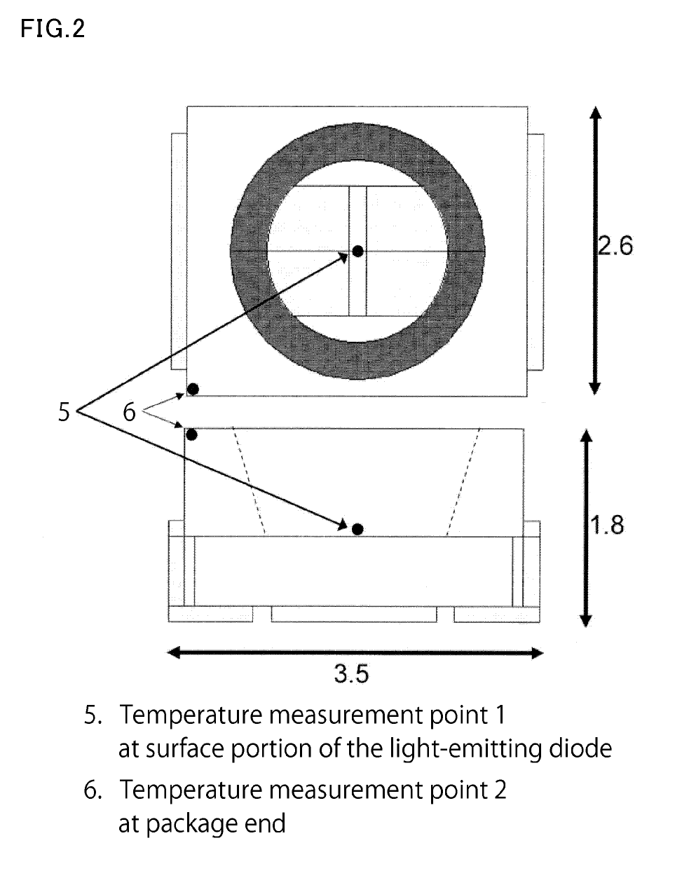

Using this curable resin composition, a package shaped as shown in FIG. 2 was produced, then, a light-emitting diode element was placed at the center of the concave portion of the package, a sealant mixture 1 was poured and cured under heating at 120° C. for 10 minutes to produce a light-emitting diode package 1, which was evaluated. A voltage was applied to the terminal of the light-emitting diode element which was used at an electric power consumption of 0.3 W for 30 minutes. When the temperature was measured after 30 minutes of use by placing fine-wire thermocouples at the surface portion of the light-emitting diode element (temperature measurement point 1 in FIG. 2) and at the package end (temperature measurement point 2 in FIG. 2), it was 162° C. at the temperature measurement point 1, and 143° C. at the temperature measurement point 2, making the temperature difference of 19° C. In addition, no detachment or cracking was observed, even when the cycle of using it at an electric power consumption of 0.3 W for 30 minutes and cooling it down for 30 minutes was repeated 100 times. The sizes in FIG. 2 are all indicated in millimeter.

### Example 2

Mixed were 10.00 g of triallyl isocyanurate as component (A), 32.42 g of FZ3772 manufactured by Nippon Unicar Company Limited (a methyl styrene modified polymethyl hydrogensiloxane) as component (B), 0.128 g of a xylene solution of platinum vinylsiloxane complex (containing 3% by weight of platinum) as component (D), and 0.127 g of 1-ethinyl-1-cyclohexanol. Added thereto were 21.34 g of titanium oxide (manufactured by ISHIHARA SANGYO KAISHA, LTD; Tipaque R820) and 341.2 g of spherical hexagonal boron nitride (manufactured by DENKI KAGAKU KOGYO KABUSHIKI KAISHA; SGPS) as component (C), and were kneaded three times with three ceramic rolls, to obtain the curable resin composition of the present invention. It was in a paste-form which was hard at room temperature, but when a small amount was placed on a hot plate heated to 150° C., the viscosity dropped temporarily and turned into a fluid state and gelled in 35 seconds.

This curable resin composition was heat-treated on a hot plate at 120° C. for 3 minutes. During this time the composition thickened, indicating that the B-stage was reached. A transfer molding machine model MF-0 manufactured by Marushichiseisakujo Co., Ltd, was used to perform transfer molding of this B-staged composition. Using a mold for four cylindrical 21 mmφ×6.4 mm samples, satisfactory molded products with no flash, crack, void or the like were obtained when molding was performed under the conditions: raw material pot temperature: room temperature; mold temperature: 140° C.; molding pressure: 150 kgf/cm²; and molding time: 120 seconds. The obtained molded product was post-cured by heating under air inside a hot air-circulating oven at 150° C. for one hour to obtain a white cured product. When the heat-conductivity of the cured product was measured, it was 3.9 W/mK.

In a manner similar to Example 1, this curable resin composition was used to prepare and evaluate a light-emitting diode package 2. A voltage was applied to the terminal of the light-emitting diode element which was used at an electric power consumption of 0.3 W for 30 minutes. The temperature after 30 minutes of use was 156° C. at the temperature measurement point 1 of FIG. 2 and 150° C. at the temperature measurement point 2 of FIG. 2, making the temperature difference of 6° C. In addition, no detachment or cracking was observed, even when the cycle of using it at an electric power consumption of 0.3 W for 30 minutes and cooling it down for 30 minutes was repeated 100 times.

### Comparative Example 1

In a manner similar to Example 1, AMODEL A-4122 (glass fiber-filled polyamide resin) manufactured by Solvay Advanced Polymers, K.K. used in conventional package for semiconductor was used to prepare and evaluate a light-emitting diode package 3. When a sample was prepared separately to measure heat conductivity, the heat conductivity of AMODEL A-4122 was 0.3 W/mK. A voltage was applied to the terminal of the light-emitting diode package 3 which was used at an electric power consumption of 0.3 W for 30 minutes. When the temperature was measured after 30 minutes of use by placing fine-wire thermocouples at the surface portion of the light-emitting diode package 3 (temperature measurement point 1 in FIG. 2) and at the package end (temperature measurement point 2 in FIG. 2), it was 164° C. at the temperature measurement point 1, and 134° C. at the temperature measurement point 2, making the temperature difference of 30° C. In addition, when the cycle of using it at an electric power consumption of 0.3 W for 30 minutes and cooling it down for 30 minutes was repeated 100 times, a crack occurred at the package-sealant interface.

### Synthesis Example 3

Introduced into a 2 L-autoclave were 696 g of toluene and 463 g of 1,3,5,7-tetramethyl cyclotetrasiloxane which, after the gaseous phase was replaced by nitrogen, were heated at a jacket temperature of 105° C. and stirred. A mixed solution of 80 g of triallyl isocyanurate, 80 g of toluene and 0.050 g of a xylene solution of platinum vinylsiloxane complex (containing 3% by weight of platinum) was added dropwise over 40 minutes. Three hours after completion of the dropwise addition, the reaction percentage of the allyl groups was verified to be at least 95% by ¹H-NMR, and the reaction was stopped by cooling. The unreacted percentage of 1,3,5,7-tetramethyl cyclotetrasiloxane was 57%. Unreacted 1,3,5,7-tetramethyl cyclotetrasiloxane and toluene were evaporated so as to be present in 1,000 ppm or less in total and a colorless transparent liquid was obtained.

The viscosity of the product was 3.0 Pa·second. When a GPC measurement of the product was performed, a multimodal chromatogram was obtained, suggesting a mixture. It was found by ¹H-NMR measurement that the main component of this mixture was a compound obtained by reacting a portion of the SiH groups of 1,3,5,7-tetramethyl cyclotetrasiloxane with the allyl groups of triallyl isocyanurate (above-mentioned reactant A). In addition, it was found that 8.8 mmol/g of SiH group was included.

### Synthesis Example 4

Introduced into a 2 L-autoclave were 720 g of toluene and 240 g of 1,3,5,7-tetramethyl cyclotetrasiloxane which, after the gaseous phase was replaced by nitrogen, were heated at a jacket temperature of 50° C. and stirred. A mixed solution of 171 g of allylglycidyl ether, 171 g of toluene and 0.049 g of a xylene solution of platinum vinylsiloxane complex (containing 3% by weight of platinum) was added dropwise over 90 minutes. After completion of the dropwise addition, the jacket temperature was raised to 60° C., reaction was continued for 40 minutes, and the reaction percentage of the allyl groups was verified to be at least 95% by ¹H-NMR. A mixed solution of 17 g of triallyl isocyanurate and 17 g of toluene was added dropwise, then, the jacket temperature was raised to 105° C., and a mixed solution of 66 g of triallyl isocyanurate, 66 g of toluene and 0.033 g of a xylene solution of platinum vinylsiloxane complex (containing 3% by weight of platinum) was added dropwise over 30 minutes. Four hours after completion of the dropwise addition, the reaction percentage of the allyl groups was verified to be at least 95% by ¹H-NMR, and the reaction was stopped by cooling. The unreacted percentage of 1,3,5,7-tetramethyl cyclotetrasiloxane was 0.8%. Unreacted 1,3,5,7-tetramethyl cyclotetrasiloxane, toluene and byproducts of allylglycidyl ether (products from internal rearrangement of the vinyl group of allylglycidyl ether (cis and trans)) were evaporated so as to be present in 5,000 ppm or less in total and a colorless transparent liquid was obtained. It was found by ¹H-NMR measurement that it was a compound obtained by reacting a portion of the SiH groups of 1,3,5,7-tetramethyl cyclotetrasiloxane with allylglycidyl ether and triallyl isocyanurate, having on average the structure indicated below (general formula (6), referred to reactant B).

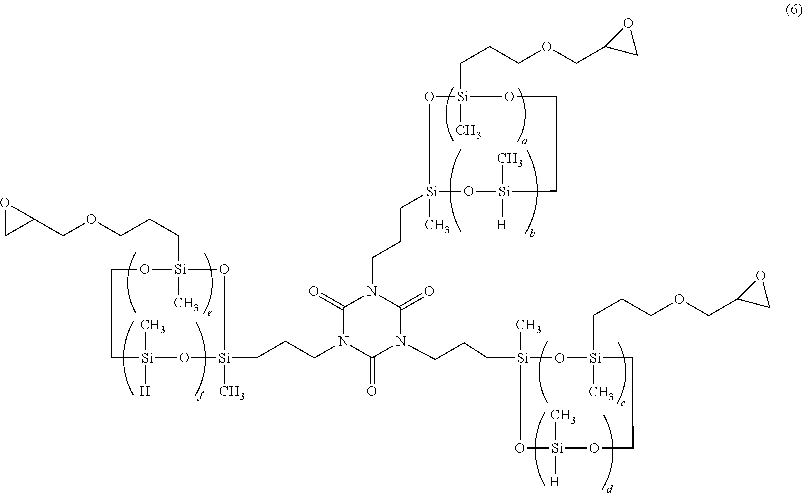

(wherein a+b=3, c+d=3, e+f=3, a+c+e=3.5, b+d+f=5.5)

### Example 3

Solution A was prepared by mixing 24.0 g of triallyl isocyanurate and 0.06 g of a xylene solution of platinum-divinyl tetramethyldisiloxane complex (containing 3% by weight of platinum), stirring the mixture followed by degassing under vacuum. In addition, 36.0 g of the product prepared in Synthesis Example 3, 0.06 g of 1-ethinyl cyclohexanol and 1.5 g of 3-glycidoxypropyl trimethoxysilane were mixed, stirred and, degassed to obtain solution B. A mixture of solution A, solution B and 582 g of zinc oxide LPZINC-5 (manufactured by Sakai Chemical Industry Co., Ltd.) was mixed using three paint rolls while cooling the rolls to suppress heat generation to obtain a curable resin composition. As the obtained composition was in a semi-solid form, it was processed into a tablet-shape by a method whereby the composition was supplied to a press container and pressed, and used for molding.

### Examples 4 to 11

Each component was mixed with the proportions indicated in Table 1 to prepare composition land composition 2. Curable resin compositions were prepared in a manner similar to Example 3 except that compositions 1 and 2 and other components were mixed with the proportions indicated in Table 2.

### Example 12

A mixture of 40.0 g of vinyl-terminated polydimethylsiloxane (DMS-V31) manufactured by Gelest, Inc., 21 g of methyl hydrosiloxane-dimethylsiloxane copolymer (HMS-301) manufactured by Gelest, Inc., 0.0001 g of a xylene solution of platinum-divinyl tetramethyldisiloxane complex (containing 3% by weight of platinum), 0.0005 g of 1-ethinyl cyclohexanol and 582 g of zinc oxide LPZINC-5 (manufactured by Sakai Chemical Industry Co., Ltd.) was mixed with three paint rolls while cooling the rolls to suppress heat generation to obtain a curable resin composition. As the obtained composition was in a semi-solid form, it was processed into a tablet-shape by a method whereby the composition was supplied to a press container and pressed, and used for molding.

### Comparative Example 2

A curable resin composition was prepared in a manner similar to Example 3 except that each component was mixed with the proportions indicated in Table 2.

### (Evaluation Methods)

The following evaluations were performed and the results were indicated in Table 2.

### (Moldability)

The thermosetting resin composition tablets from each Example and Comparative Example were molded by the transfer molding method at a molding temperature of 150° C. for 5 minutes. The obtained molded product was subjected to post-curing (after-curing) in a hot air oven at 150° C. for one hour and at 180° C. for 30 minutes. The resin flowability into the mold at molding was evaluated by the following criteria: extremely satisfactory: A; molding possible with almost no problem: B; occasional occurrence of molding defect such as insufficient resin filling: C; and occurrence of insufficient resin filling: D.

### (Heat Conductivity)

The thermosetting resin composition tablets from each Example and Comparative Example were press-molded using a stainless steel (SUS304) disk-type frame with an internal dimension of 30 mmφ and a thickness of 5 mm, under the condition of 150° C./5 minute, with a PET film as a release film. The produced disk-shaped press molded product was post-cured in an oven under the conditions of 150° C./1 hour and 180° C./0.5 hours. The heat conductivity of the obtained molded product was calculated with a heat conductivity meter (hot disc method) manufactured by Kyoto Electronics Manufacturing Co., LTD. using a 4φ sensor.

### (Reflectance)

The thermosetting resin composition tablets from respective Examples and Comparative Examples were press-molded using a stainless steel (SUS304) rectangle frame with internal dimensions of BO mm×50 mm and a thickness of 0.5 mm, under the condition of 150° C./5 minute, with a PET film as a release film. The produced rectangular plate-shaped press molded product was post-cured in an oven under the conditions of 150° C./1 hour and 180° C./0.5 hour. The total reflection at 450 nm of the obtained molded product was measured using a spectrophotometer equipped with an integrating sphere (manufactured by JASCO Corporation; UV-visible spectrophotometer V-560) and was defined as the value for “450 nm reflectance (initial)”. The reflectance was measured using the Spectralon plate manufactured by Labsphere, Inc., as the standard plate. In addition, this molded product was heat-treated in a hot air circulating oven at 180° C. for 4 hours, then, in a manner similar to the above, total reflection at 450 nm was measured and defined as the value for “450 nm reflectance (after heat-treatment)”.

TABLE 1

| | | Composition 1 | Composition 2 |
|---|---|---|---|
| Component (A) | Triallyl isocyanurate | 40.2 g | 2.9 g |
| | Diallyl monoglycidyl | | 28.1 g |
| | isocyanurate | | |
| Component (B) | Product of Synthesis | 59.8 g | |
| | Example 3 | | |
| | Product of Synthesis | | 69.0 g |
| | Example 4 | | |
| Component (C) | Xylene solution | 0.05 g | 0.018 g |
| | of platinum | | |
| | vinylsiloxane | | |
| | complex (containing | | |
| | 3% by weight | | |
| | of platinum) | | |
| Curing | 1-Ethinyl | 0.3 g | 0.1 g |
| retardant | cyclohexanol | | |

TABLE 2

| | | Example 3 | | Example 4 | | Example 5 | | Example 6 | | Example 7 | | Example 8 | |
|---|---|---|---|---|---|---|---|---|---|---|---|---|---|
| | | wt % | vol % | wt % | vol % | wt % | vol % | wt % | vol % | wt % | vol % | wt % | vol % |
| Component (A) | Solution A and | 9.3 | 33.4 | | | | | | | | | | |
| and Cmponent | Solution B | | | | | | | | | | | | |
| (B) | Composition 1 | | | 8.3 | 30.0 | 7.9 | 25.0 | 5.7 | 20.0 | 7.0 | 25.0 | 8.8 | 30.0 |
| | Composition 2 | | | | | | | | | | | | |
| | DMS-V31/HMS-301 | | | | | | | | | | | | |
| Component (C) | ZnO (zinc oxide grade | | | | | 38.4 | 25.0 | 83.3 | 60.0 | | | | |
| | 1) | | | | | | | | | | | | |
| | ZnO (LPZINC-5) | 90.7 | 66.6 | 81.5 | 60.0 | | | | | 69.0 | 50.0 | 85.6 | 60.0 |
| | Alumina AS-40 | | | | | 53.7 | 50.0 | | | | | | |
| | Alumina ASFP-20 | | | | | | | | | 24.0 | 25.0 | | |
| | Boron nitride HP-40 | | | | | | | | | | | | |
| Other filler | Titanium oxide PC-3 | | | 10.2 | 10.0 | | | | | | | | |
| | Silica MSR-3500 | | | | | | | 11.0 | 20.0 | | | | |
| | Silica SO—C2 | | | | | | | | | | | 5.6 | 10.0 |

| | | | | | | |
|---|---|---|---|---|---|---|
| Moldability | A | A | A | B | A | A |
| Heat conductivity (W/mK) | 2.9 | 3.1 | 4.2 | 3.5 | 4.1 | 3.0 |
| 450 nm reflectance (initial) (%) | 99 | 100 | 99 | 99 | 99 | 99 |
| 450 nm reflectance (after heat- | 99 | 100 | 99 | 99 | 99 | 99 |
| treatment) (%) | | | | | | |

| | | | | | | | | | | Comparative | |
|---|---|---|---|---|---|---|---|---|---|---|---|
| | | Example 9 | | Example 10 | | Example 11 | | Example 12 | | Example 2 | |
| | | wt % | vol % | wt % | vol % | wt % | vol % | wt % | vol % | wt % | vol % |
| Component (A) | Solution A and | | | | | | | | | | |
| and Cmponent | Solution B | | | | | | | | | | |
| (B) | Composition 1 | 10.2 | 25.0 | 12.6 | 25.0 | | | | | 17.6 | 33.4 |
| | Composition 2 | | | | | 9.3 | 33.4 | | | | |
| | DMS-V31/HMS-301 | | | | | | | 9.3 | 33.4 | | |
| Component (C) | ZnO (zinc oxide grade | 49.6 | 25.0 | 24.5 | 10.0 | | | | | | |
| | 1) | | | | | | | | | | |
| | ZnO (LPZINC-5) | | | | | 90.7 | 66.6 | 90.7 | 66.6 | | |
| | Alumina AS-40 | | | | | | | | | | |
| | Alumina ASFP-20 | | | | | | | | | | |
| | Boron nitride HP-40 | 40.2 | 50.0 | | | | | | | | |
| Other filler | Titanium oxide PC-3 | | | | | | | | | 31.9 | 16.6 |
| | Silica MSR-3500 | | | 62.9 | 65.0 | | | | | 50.5 | 50.0 |
| | Silica SO—C2 | | | | | | | | | | |

| | | | | | |
|---|---|---|---|---|---|
| Moldability | B | A | A | C | A |
| Heat conductivity (W/mK) | 4.9 | 1.5 | 2.9 | 2.9 | 0.7 |
| 450 nm reflectance (initial) (%) | 96 | 99 | 100 | 84 | 100 |
| 450 nm reflectance (after heat- | 96 | 99 | 100 | 80 | 100 |
| treatment) (%) | | | | | |

It is clear that the molded products from respective Examples have excellent heat conductivity as compared to Comparative Example 2, and thus, that the molded products have excellent heat dissipation.

Embodiments and Examples disclosed herein are illustrative on all points, and not limiting. The scope of the present invention is indicated, not by the above description, but by the claims, and intends to include equivalents of the claims as well as all modifications within the scope.

1. A curable resin composition containing:
(A) an organic compound containing in a molecule at least two carbon-carbon double-bonds having reactivity with a SiH group;
(B) a compound containing in a molecule at least two SiH groups; and
(C) a heat-conductive filler, which is at least one species selected from the group consisting of a-alumina, hexagonal boron nitride, aluminum nitride and zinc oxide, and is a particle wherein a primary particle has a number average particle diameter of at least 0.10 μm,
wherein heat conductivity after curing is at least 0.8 W/mK.

2. The curable resin composition according to claim 1,
wherein the compound (B) is a compound obtained by a hydrosilylation reaction between an organic compound (B-1) containing in a molecule at least two carbon-carbon double-bonds having reactivity with a SiH group and a silicon compound (B-2) containing at least two SiH groups in a molecule.

3. The curable resin composition according to claim 2, wherein the organic compound (B-1) has a heterocyclic skeleton or an alicyclic skeleton.

4. The curable resin composition according to claim 3, wherein the organic compound (B-1) is a compound represented by the following general formula (1): 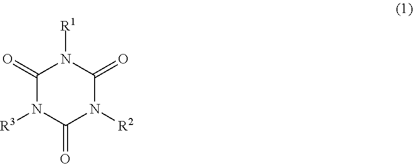
wherein R¹, R² and R³ all represent organic groups, and at least two of them are alkenyl groups.

5. The curable resin composition according to claim 1, wherein the heat-conductive filler (C) is zinc oxide.

6. The curable resin composition according to claim 5, wherein the volume ratio of the zinc oxide is 5 to 90% by volume of the whole composition.

7. The curable resin composition according to claim 1, further containing a hydrosilylation catalyst (D).

8. The curable resin composition according to claim 1, further containing a silica (E).

9. A heat-conductive resin molded product obtained by a hydrosilylation reaction of the curable resin composition according to claim 1.

10. The heat-conductive resin molded product according to claim 9, which has the initial reflectance at a wavelength of 450 nm of at least 75%.

11. A package for semiconductor containing the heat-conductive resin molded product according to claim 9.

12. The package for semiconductor according to claim 11, using a light-emitting diode as the semiconductor.
